(19) United States
(12) Patent Application Publication
(10) Pub. No.: US 2023/0316029 A1
(43) Pub. Date: Oct. 5, 2023

(54) Systems And Methods For Data Transfer And Platform Integration Using Quick Response (QR) Codes

(71) Applicant: Xactware Solutions, Inc., Lei, UT (US)

(72) Inventors: Nicholas Sykes, American Fork, UT (US); Ryan James Huntbach, Berea, KY (US); Jeremy David Nicholls, St. George, UT (US); Cortney Reber, Eagle Mountain, UT (US); Devan Morriss, Orem, UT (US)

(73) Assignee: Xactware Solutions, Inc., Lei, UT (US)

(21) Appl. No.: 18/127,918

(22) Filed: Mar. 29, 2023

Related U.S. Application Data
(60) Provisional application No. 63/324,881, filed on Mar. 29, 2022.

(51) Int. Cl. G06K 19/06; G06F 21/60

(52) U.S. Cl. CPC G06K 19/06037; G06F 21/602

(57) ABSTRACT

Systems and methods for data transfer and platform integration using quick response (QR) codes are provided. The system generates first item data associated with a first property item, generates one or more QR codes that encrypt and store the first item data, and sends or displays the one or more QR codes. The system reads the one or more QR codes from an application program installed on a computing device to obtain the encrypted first item data. The system decrypts, using a decryption key, the encrypted first item data to obtain the first item data from the QR code. The system generates, by the application program, first analysis data based at least in part on the first item data.

### RELATED APPLICATIONS

The present application claims priority of U.S. Provisional Patent Application Ser. No. 63/324,881 filed on Mar. 29, 2022, the entire disclosure of which is expressly incorporated herein by reference.

### BACKGROUND

### Technical Field

The present disclosure relates generally to the field of data processing. More specifically, the present disclosure relates to systems and methods for data transfer and platform integration using quick response (QR) codes.

### RELATED ART

In the insurance underwriting, building construction, solar, field services, and real estate industries, computer-based systems for estimating the cost of repairs and reconstruction for physical structures (e.g., residential homes, commercial buildings, etc.) and objects within those homes (e.g., furniture, cabinets, appliances, roofing, etc.) are becoming increasingly important. In particular, to accurately estimate cost of repairs and reconstruction for a physical structure, one must have an accurate set of data which adequately describes that structure (e.g., material, manufacturer, model or brand, color, price for similar kind and quality to be purchased, etc.).

With the advent of mobile data capturing devices including phones and tablets, it is now possible to gather and process accurate data from sites located anywhere in the world. However, it is difficult to transfer and/or share the gathered data and/or processed data across multiple devices and/or multiple software applications due to various factors, such as slow data transfer rates, inadequate computer network performance, limited data storage capacity, a lack of supporting platforms, and disparities in data formats, operating environments, application architectures, and operating systems among the devices and/or software applications.

Accordingly, what would be desirable are systems and methods for data transfer and platform integration using quick response (QR) codes which address the foregoing, and other, needs.

### SUMMARY

The present disclosure relates to systems and methods for data transfer and platform integration using quick response (QR) codes. The system generates first item data (e.g., property claim information, property item information, etc.) associated with a first property item (e.g., a damaged physical structure, a damaged content item, etc.). The system arranges the first item data in a first location (e.g., listing the first item data in a row of a table). The system generates one or more quick-response (QR) codes that encrypts and stores the first item data, and sends or displays the one or more QR codes. The system reads the one or more QR codes from an application program installed on a computing device to obtain the encrypted first item data. The system decrypts, using a decryption key, the encrypted first item data to obtain the first item data from the QR code. The system generates, by the application program, first analysis data (e.g., price, material, manufacturer, model or brand, color, price for similar kind and quality to be purchased for a sample submitted by a user of the application program) based at least in part on the first item data. The system sends the first analysis data by the application program and receives the first analysis data. The system places the first analysis data in the first location (e.g., the same row of the table as the first item data).

To generate the QR codes, the system converts the first item data into a data transfer format (e.g., JavaScript object notation (JSON) format) for transferring the first item data from the insurance claims estimating software to the application program. The system encrypts the first item data in the data transfer format to protect personally identifiable information (e.g., using the advanced encryption standard (AES) encryption (e.g., AES-128), initialization vector (IV), or other techniques). The system encodes the encrypted first item data in the data transfer format to convert non-printable characters of the encrypted first item data into printable characters. The system generates the one or more QR codes which store the encoded and encrypted first item data in the data transfer format. If data is greater than a payload capability of a single generated QR code, the system can generate multiple QR codes to represent the encrypted first item data.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIGS. 2-3 are flowcharts illustrating overall processing steps carried out by the system of the present disclosure;

FIGS. 4-6 are screenshots illustrating example user interfaces of the system of the present disclosure;

FIG. 7 is a flowchart illustrating step 56 of FIG. 2 in greater detail;

FIG. 8 is a diagram illustrating operation of step 56 in greater detail; and

FIG. 9 is a diagram illustrating hardware and software components capable of being utilized to implement the system of the present disclosure.

### DETAILED DESCRIPTION

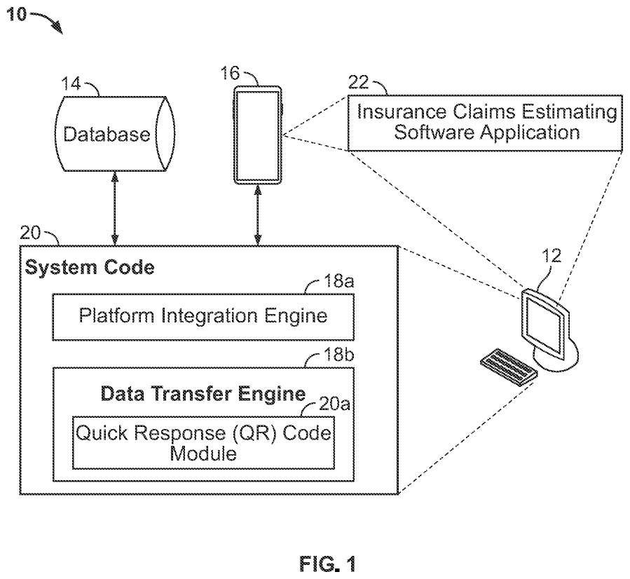

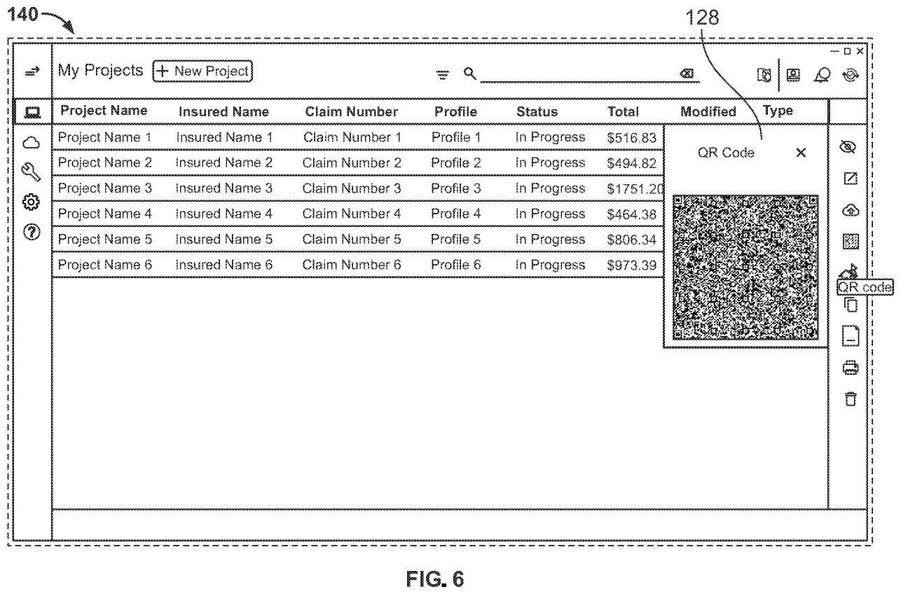

The present disclosure relates to systems and methods for transfer and platform integration using quick response (QR) codes, as described in detail below in connection with FIGS. 1-9.

Turning to the drawings, FIG. 1 is a diagram illustrating an embodiment of the system 10 of the present disclosure. The system 10 can be embodied as a central processing unit 12 (processor) in communication with a database 14 and a computing device 16. The processor 12 and the computing device 16 can include, but is not limited to, a computer system, a server, a personal computer, a cloud computing device, a smart phone, or any other suitable device programmed to carry out the processes disclosed herein. Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

The database 14 includes data associated with one or more properties (e.g., residential properties such as single family, condo/townhouse, mobile home, multi-family and other, and commercial properties such as a company site, a commercial building, a retail store, etc.). Example data includes data transferred from the computing device 16 (e.g., data associated with a particular property structure and/or item to be claimed), data transferred from other computing devices (e.g., data associated with an assignment to process a property claim), data obtained from one or more external database (e.g., pricing databases provided by XACTWARE SOLUTIONS, INC, multiple listing service (MLS), and/or other suitable database associated with properties). The database 14 can further include one or more outputs from various components of the system 10 (e.g., outputs from a platform integration engine 18a, a data transfer engine 18b, a quick response (QR) code module 20a, and/or other components of the system 10).

The system 10 includes an application embodied as system code 20 (non-transitory, computer-readable instructions) stored on a computer-readable medium and executable by the hardware processor 12 or one or more computer systems and/or by the mobile device 16. The system code 20 can include various custom-written software modules that carry out the steps/processes discussed herein, and can include, but is not limited to, the platform integration engine 18a, the data transfer engine 18b, the QR code module 20a, and/or other components of the system 10. The system code 20 can be programmed using any suitable programming languages including, but not limited to, C, C++, C#, Java, Python, or any other suitable language. Additionally, the system code 20 can be distributed across multiple computer systems in communication with each other over a communications network, and/or stored and executed on a cloud computing platform and remotely accessed by a computer system in communication with the cloud platform. The system code 20 can communicate with the database 14, which can be stored on the same computer system as the system code 20, or on one or more other computer systems (e.g., the computing device 16 or other remote computing device) in communication with the system code 20.

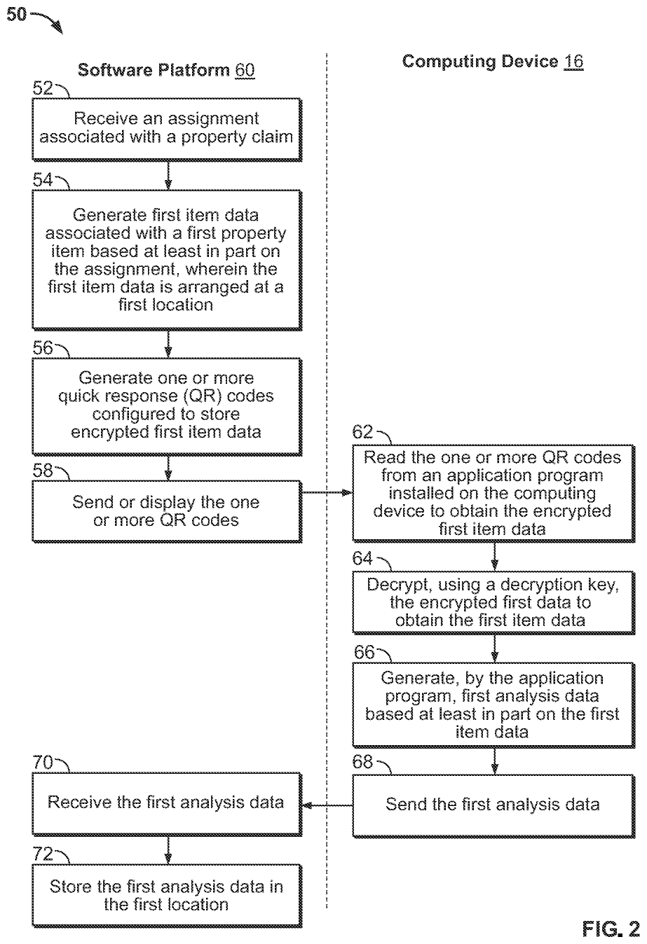

It is noted that the platform integration engine 18a could integrate a software platform with the computing device 16 and allow the software platform to communicate with one or more application programs installed on the computing device 16. For example, the software platform can transfer data to application programs installed on the computing device 16 and the application programs can return data to the software platform. A software platform (e.g., software platform 60 in FIG. 2) can provide an operating environment in which one or more computer software applications, such as an insurance claims estimating software application 22 or other application programs or computer programs that are designed for an end user, programming software, system software, etc., performing different functionalities can be executed. The software platform can be a desktop computer platform, an online browser platform, a mobile device platform, a cloud platform, a virtual machine platform, or some combination thereof. The software platform can seamlessly integrate and execute one or more computer software applications, such as insurance claims estimating software for any restoration job throughout all stages of a repair process, claims management software for claims professionals to send, receive, and manage estimate data in real time, software for claims professionals to collaborate with policyholders for improving customer satisfaction and reduce claims-handling costs, software for estimating personal contents, software for tracking contents pack out and pack back, software for providing natural hazard analysis reports from weather events in near real time, software for job management and tracking, and other suitable software associated with property insurance, or some combination thereof.

The software platform and application programs (e.g., software application 22) can be installed or executed on the same computing device (e.g., both can be installed or executed on the processor 12 or the computing device 16) or different computing devices (e.g., the software platform can be installed or executed on the processor 12 or other computing device that communicates with the processor 12 and/or the computing device 16, and the application programs are installed or executed on the computing device 16). The software platform and the application programs can be used by the same user (e.g., an insurer, an adjuster, a restoration contractor, a reconstruction contractor, a service provider, and other suitable user who uses both the software platform and application programs) or different users (e.g., the software platform can be used by an insurer, an adjuster, a restoration contractor, a reconstruction contractor, a service provider, and other suitable user who uses the software platform, and the application programs can be used by an homeowner or other suitable user who uses the application programs). Advantageously, the data transfer engine 18b can securely and efficiently transfer data between the software platform and application programs via a QR code generated by the QR code module 20a.

FIG. 2 is a flowchart illustrating overall processing steps 50 carried out by the system 10 of the present disclosure. Beginning in step 52, the system 10 receives an assignment associated with a property claim. A property claim refers to a claim or demand arising from or related to direct, physical loss or damage to a real estate property that is covered by property insurance policies. The software platform 60 of the system 10 executes one or more computer software applications. For example, first computer software application and second computer software application can be executed on the software platform 60. Further, one of the computer software applications of the software platform 60 can receive data/information/signals/instructions from another of the other computer software applications. For example, the second computer software application can receive an assignment (e.g., estimating the cost of repairs and reconstruction for physical structures) from the first computer software application.

In step 54, the system 10 generates a first item data associated with a first property item based at least in part on the assignment. A property item can be lost or damaged real estate property, physical structures (e.g., walls, floor, etc.), content items (e.g., appliance, light fixture, furniture, etc.), and other suitable physical structures and/or content items associated with a real estate property. Examples of data associated with a property item include adjuster's contact information (e.g., name, phone number, email address, fax number, etc.), adjusting company information (e.g., name, contact information, address, etc.), contract's contact information, category (CAT) code, property claim information (e.g., claim number, claim type, data of loss, insurance policy type, insured name, etc.), property item information (e.g., location where the property item is lost or damaged, item name, item identifier, etc.), transaction information (e.g., transaction identifier, transaction date, etc.), and other suitable information associated with the property item. The assignment can include more than one property items. The system 10 can generate data for each property item of the assignment, such as first item data for the first property item as described above, second data for second property item, and so forth.

Further, the system 10 can arrange the first item data in a first location. For example, the system 10 can place the first item data in a first row or first column of a data structure such as a spreadsheet, list, web-based user interface, graphical user interface, etc., the second data in a second row or second column of the spreadsheet, list, web-based user interface, graphical user interface, and so forth. Each item data can have a unique item identifier (e.g., a folder tree) to ensure that the computing device 16 returns analysis data to a correct location.

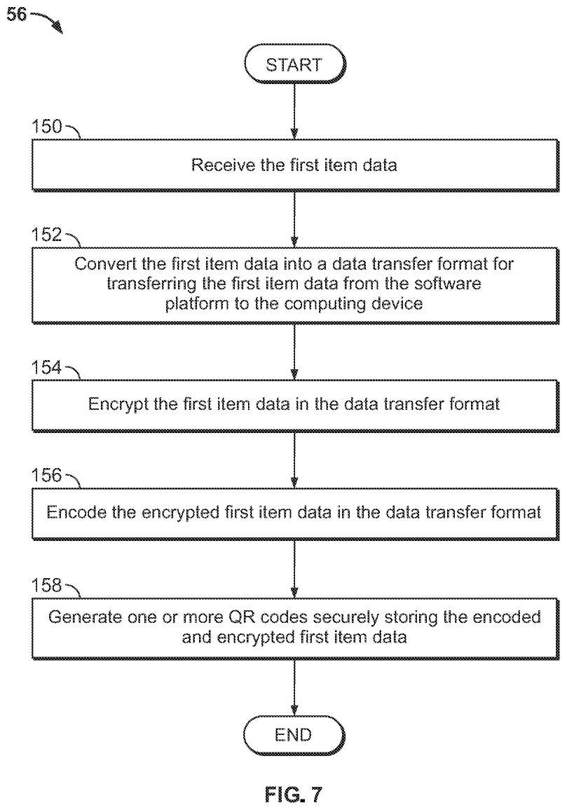

In step 56, the system 10 generates one or more quick-response (QR) codes that securely store encrypted versions of the first item data in the QR code, as further described in FIG. 7. In step 58, the system 10 sends or displays the one or more QR codes such that QR code readers (e.g., a QR code reader of the computing device 16) can read the QR codes. If the software platform 60 is installed or executed on the computing device 16 or if the software platform 60 is installed or executed on a different computing device that is close to the computing device 16, the system 10 can display the QR codes. If the software platform 60 is installed or executed on a different computing device further away from the computing device 16, the system 10 can send the QR codes from the software platform 60 to the computing device 16. The computing device 16 can display the QR codes. Because the QR code is displayed in a computer screen, damage/distortion of the QR code that often occurs in a physical medium (e.g., sticker) is greatly reduced. The lowest error correction level for generating the QR code can be used, which maximizes the payload capacity of the QR code to enable the QR code to transfer data. In contrast, the conventional QR code has limited payload capacity that impedes the conventional QR code from transferring data.

In step 62, the system 10 reads the one or more QR codes from an application program installed on the computing device 16 to retrieve the encrypted first item data from the QR code. For example, the application program can read the one or more QR codes via a camera of the computing device 16 to extract the encrypted first item data. In step 64, the system 10 decrypts, using a decryption key, the encrypted first item data to obtain the first item data. The decryption key can be the same as the encryption key used to encrypt the first item data (e.g., if symmetric encryption is used) or it can be different from the encryption key (e.g., if asymmetric encryption is used). The system 10 can send the decryption key to the computing device 16 when the system 10 encrypts the first item data described in step 56, as further described in FIG. 7.

In step 66, the system 10 generates, by the application program, first analysis data based at least in part on the first item data. Analysis data refers to an analysis result generated by the application program after analyzing a property item. Examples of analysis data for a property item include price, material, manufacturer, model or brand, color, price for similar kind and quality to be purchased, the corresponding item data and information associated with the item data as described above in step 54, and other suitable information associated with the property item.

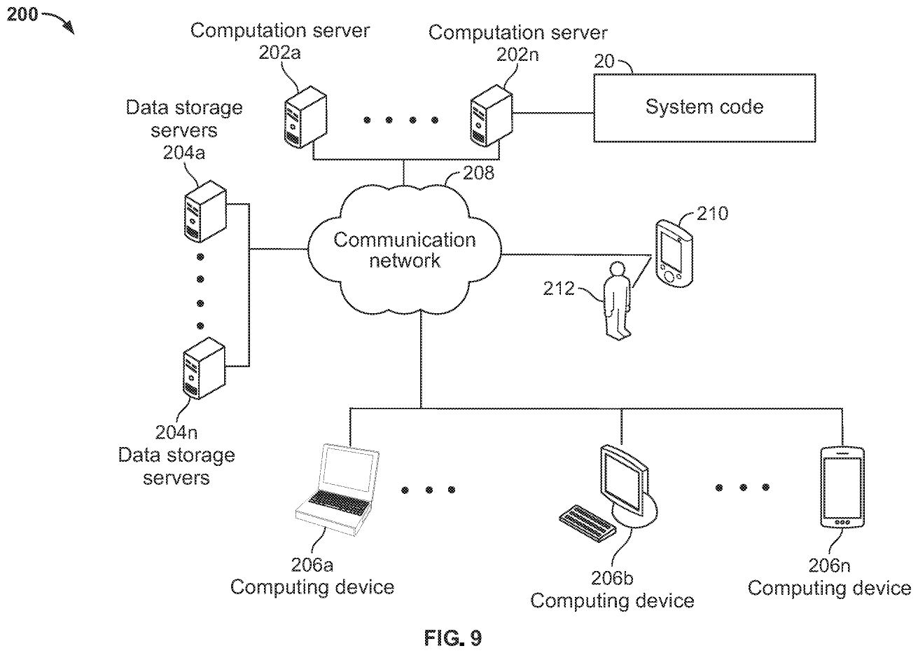

In step 68, the system 10 sends the first analysis data to the software platform 60 (e.g., via a communication network as described in FIG. 1 and FIG. 9). Then, in step 70, the system 10 receives the first analysis data. Finally, in step 72, the system 10 stores the first analysis data in the first location. For example, continuing with the above example described in step 54, the system 10 can place the first analysis data in the first row or first column based on the item identifier.

It should be understood that the above steps can be performed by the platform integration engine 18a and data transfer engine 18b. It should be also understood that the software platform 60 and the application program can be installed or executed on the same computing device or on different computing devices. For example, the software platform 60 can be installed or executed on the same computing device 16 as the application program (such as the application 22 of FIG. 1), or on processor 12, or other suitable remote computer devices in communication with the processor 12 and/or the computing device 16.

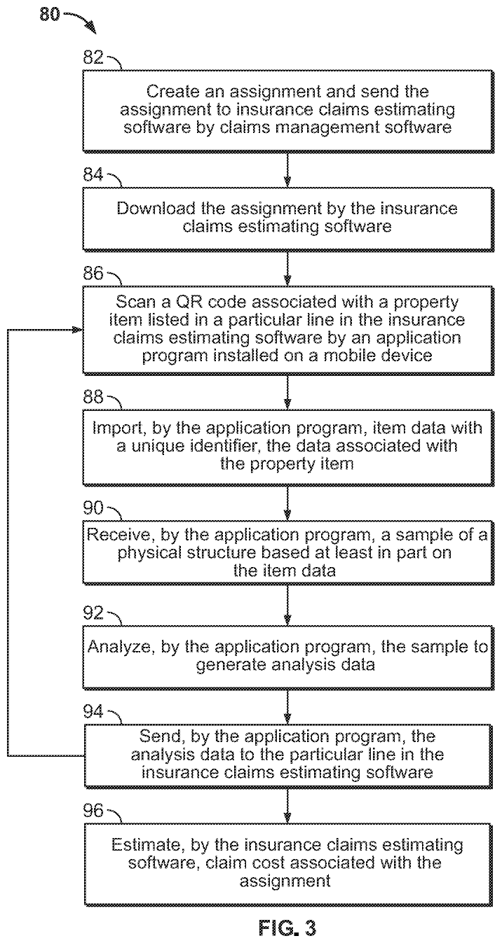

FIG. 3 is a flowchart 80 showing additional processing steps carried out by the system 10 of the present disclosure. Beginning in step 82, the insurance claims management software application of the system 10 creates an assignment and sends the assignment to insurance claims estimating software 22. In step 84, the insurance claims estimating software 22 downloads the assignment. In step 86, an application program installed on a mobile device (e.g., the computing device 16) scans a QR code associated with a property item listed in a particular line in the insurance claims estimating software 22. In step 88, the application program imports item data with a unique identifier (e.g., a folder tree). The item data is associated with the property item. In step 90, the application program receives a sample of a physical structure based at least in part on the item data. For example, a user of the application program captures a picture of the physical structure via a camera of the mobile device and uploads the picture to the application program with or without submitting additional information associated with the physical structure (e.g., brand, model, color, etc.). In step 92, the application program analyzes the sample to generates analysis data for the sample. In step 94, the application program sends the analysis data to the particular line in the insurance claims estimating software. Steps 86-94 are repeated until all the property items listed in the insurance claims estimating software receive corresponding analysis data. In step 96, the insurance claims estimating software estimates claim cost associated with the assignment (e.g., cost of repairs and reconstruction for the physical structures, labor cost, and/or other suitable cost associated with the assignment).

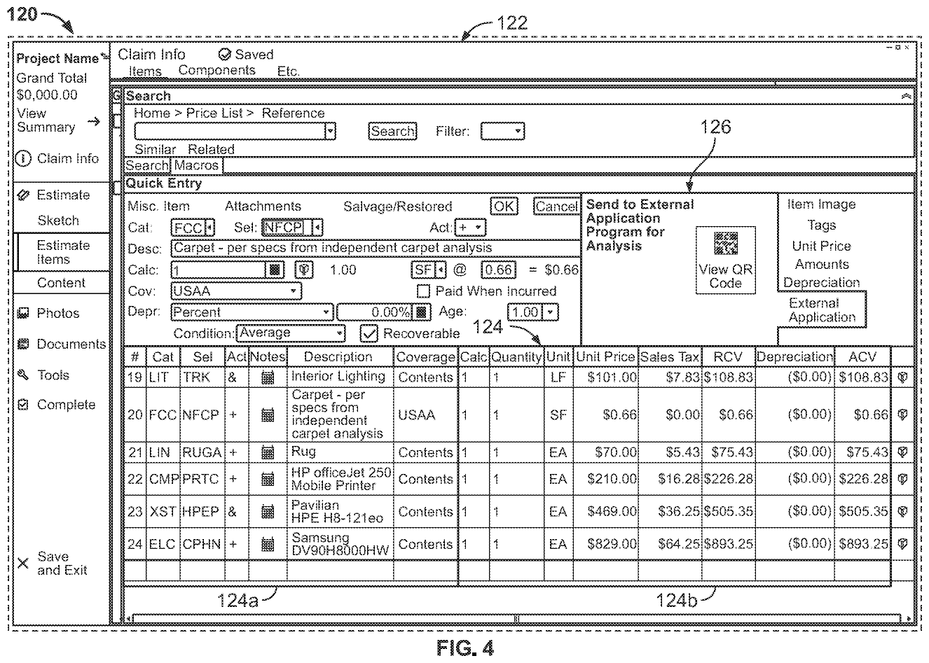

FIGS. 4-6 are screenshots 120, 130, and 140, respectively, illustrating example user interfaces of the system of the present disclosure. An user interface 122 of insurance claims estimating software 22 presents multiple items (e.g., interior lighting, carpet, rug, printer, electronic device, etc.) in a table 124. Each item is listed in a line of the table 124. Item data generated by the insurance claims estimating software is listed in a first table portion 124a and analysis data generated by an external application program (e.g., an application program that is installed on the computing device 16 externally to the insurance claims estimating software) is listed in a second table portion 124b. The insurance claims estimating software can transfer the item data associated with a particular item (e.g., carpet) to the external application program via a QR code presented in the external application program portion 126. An example QR code 128 associated with the item #20 carpet is presented in the screenshots 130 and 140.

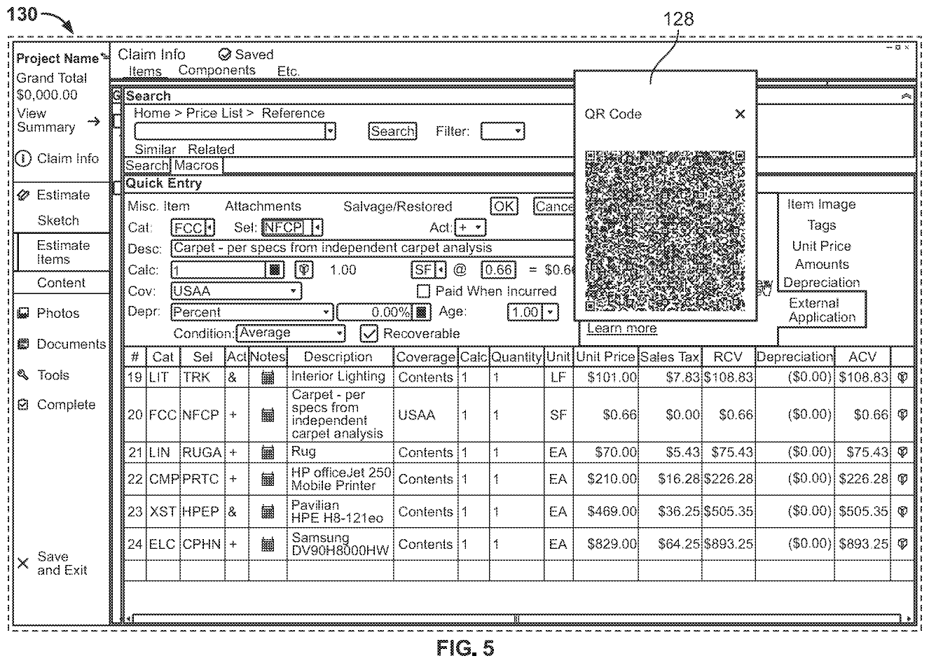

FIG. 7 is a flowchart illustrating step 56 of FIG. 2 in greater detail. Beginning in step 150, the system 10 receives the first item data (e.g., item data for the carpet shown in FIGS. 4 and 5). In step 152, the system 10 converts the first item data into a data transfer format for transferring the first item data from the software platform 60 to the computing device 16. For example, the system 10 can convert the first item data into a file format for storing data (e.g., an open standard file format) and/or converting from one file or data structure to another (e.g., data exchange format, data interchange format, etc.), such as converting the first item data into a JavaScript object notation (JSON) format by a serialization process that refers to a process of converting data into a string to store the data and/or or transmit the data to memory, a database, or a file of a computing device. It is noted that JSON is not the only format capable of being utilized by the systems and methods disclosed herein. Indeed, other suitable formats/languages, such as extensible markup language (XML), “Yet Another Markup Language” (YAML), comma-separated values (CSV), etc., could be utilized.

In step 154, the system 10 encrypts the first item data in the data transfer format. For example, the system 10 can execute a symmetric encryption algorithm or an asymmetric encryption algorithm to convert the first item data in the data transfer format into ciphertext. The system 10 further generates a decryption key same as the encryption key used in the symmetric encryption algorithm or different from the encryption key used in the asymmetric encryption algorithm. The system 10 can send the decryption key to the application program installed on the computing device 16 and/or the computing device 16. Due to this built-in encryption mechanism of the system 10, the generated QR codes can protect the data they contain. In contrast, information contained in the conventional QR codes is accessible to anyone who scans the conventional QR codes without any data protections.

In step 156, the system 10 encodes the encrypted first item data in the data transfer format. For example, the system 10 can execute one or more encoding algorithms (e.g., Base64 encoding or other suitable encoding algorithm) to assign binary numbers to the encrypted first item data. The one or more encoding algorithms can further convert non-printable characters of the encrypted first item data into printable characters such that the non-printable characters outputted from the encryption algorithm can be read by “off the shelf” QR code readers, which overcome the challenge brought by the encryption step to the “off the shelf” QR code readers. After encoding, the “off the shelf” QR code reader can successfully interpret the payload of the QR code generated by the system 10.

In step 158, the system 10 generates the one or more QR codes that securely store the encoded and encrypted first item data. If data is greater than a payload of a single generated QR code, the system 10 can generate multiple QR codes to represent the data. For example, the system 10 can generate a first QR code indicative of a first portion of the encoded and encrypted first item data in the data transfer format and a second QR code indicative of a second portion of the above data. The first QR code combined with the second QR code can represent a complete set of the above data.

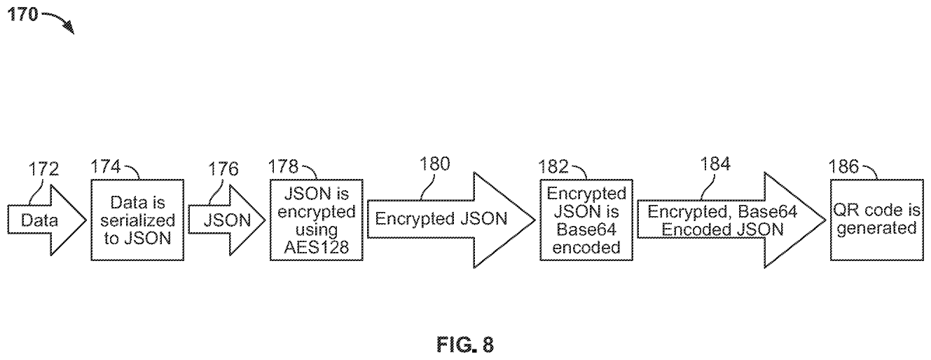

FIG. 8 is a flowchart illustrating an embodiment 170 of step 56 in greater detail. Beginning in step 172, the system 10 sends data (e.g., the first item data from step 54) to step 174. In step 174, the system 10 serializes the data to a JSON format. In step 176, the system 10 sends the data in a JSON format to step 178. In step 178, the system 10 encrypts the data in the JSON format using the advanced encryption standard (AES) encryption (e.g., AES-128) to protect personally identifiable information. In step 180, the system 10 sends the encrypted data in the JSON format to step 182. In step 182, the system 10 encodes the encrypted data in the JSON format using Baes64 encoding that converts non-printable characters of the encrypted data to printable characters. In step 184, the system 10 sends the encoded and encrypted data in the JSON format to step 186. In step 186, the system 10 generates a QR code indicative of the encoded and encrypted data in the JSON format.

FIG. 9 a diagram illustrating computer hardware and network components on which the system 200 can be implemented. The system 200 can include a plurality of computation servers 202a-202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (which can be embodied as system code 20). The system 200 can also include a plurality of data storage servers 204a-204n for storing data and QR codes. A user device 210 can include, but it not limited to, a laptop, a smart telephone, and a tablet to access and/or execute software platform (e.g., the software platform 60) and communicate with remote computing devices 206a-206n. The remote computing devices 206a-206n can provide analysis data associated with physical structures. The remote computing devices 206a-206n can include, but are not limited to, a laptop 206a, a computer 206b, and a mobile device 206n with an imaging device (e.g., camera). The computation servers 202a-102n, the data storage servers 204a-204n, the remote computing devices 206a-206n, and the user device 210 can communicate over a communication network 208. Of course, the system 200 need not be implemented on multiple devices, and indeed, the system 200 can be implemented on a single (e.g., a personal computer, server, mobile computer, smart phone, etc.) without departing from the spirit or scope of the present disclosure.

An important aspect of the systems and methods of the present disclosure is that the QR codes disclosed herein could be utilized to store data collected by a user device in instances where the user does not have network connectivity, for later transfer of the information stored in the QR code at a time when network connectivity is restored. For example, if an insurance adjuster is dispatched into a location where a natural event such as a hurricane has caused cell phone and network (e.g. WiFi) outages, the adjuster is not reliant on such connectivity in order to perform his/her job at the location. This is because the system allows the user to gather necessary data at the location and encrypts and stores the information in the QR code itself. Once the adjuster is at a location where network connectivity is present, the adjuster can utilize the QR code to transfer the stored information to another program, such as an insurance claims processing software platform or other platform. In such circumstances, the QR code serves a reliable data storage and transfer mechanism that is not dependent on network connectivity.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A system for data transfer and platform integration using quick response (QR) codes, comprising:
a computing device in communication with a software platform, the computing device programmed to:
execute an application program installed on the computing device;
read one or more QR codes from the application program to obtain a first encrypted data item, the one or more QR codes transmitted to the application program from the software platform;
decrypt, using a decryption key, the first encrypted data item to obtain a first data item;
generate, by the application program, first analysis data based at least in part on the first data item; and
transmit the first analysis data to the software platform for processing by the software platform.

2. The system of claim 1, wherein the software platform receives and stores the first analysis data.

3. The system of claim 1, wherein prior to transmission of the QR code to the application program, the software platform receives an assignment associated with a property claim.

4. The system of claim 3, wherein the software platform generates the first item data based at least in part on the assignment.

5. The system of claim 4, wherein the software platform encrypts the first item data to generate the encrypted first item data and stores the encrypted first item data in the QR code.

6. The system of claim 5, wherein the software platform sends the QR code to the computing device.

7. The system of claim 5, wherein the software platform displays the QR code.

8. The system of claim 1, wherein the application program comprises an insurance claims estimating software application, and wherein the computing device is further programmed to download an insurance claims estimating assignment.

9. The system of claim 8, wherein the computing device is further programmed to scan a QR code associated with a property item listed in a particular line in the insurance claims estimating software application.

10. The system of claim 9, wherein the computing device is further programmed to import item data with a unique identifier, the item data associated with a property item.

11. The system of claim 10, wherein the computing device is further programmed to receive a sample of a physical structure based at least in part on the item data.

12. The system of claim 11, wherein the computing device is further programmed to analyze the sample to generate analysis data.

13. The system of claim 12, wherein the computing device is further programmed to send the analysis data to the particular line in the insurance claims estimating software application.

14. The system of claim 13, wherein the insurance claims estimating software application estimates a claim cost associated with the assignment.

15. The system of claim 1, wherein the first item data is converted into a data transfer format for transferring the first item data from the software platform to the computing device.

16. The system of claim 15, wherein the first item data is encrypted in the data transfer format.

17. The system of claim 16, wherein the encrypted first item data is encoded in the data transfer format.

18. A method for data transfer and platform integration using quick response (QR) codes, comprising the steps of:
executing, at a computing device in communication with a software platform, an application program installed on the computing device;
reading one or more QR codes from the application program to obtain a first encrypted data item, the one or more QR codes transmitted to the application program from the software platform;
decrypting, using a decryption key, the first encrypted data item to obtain a first data item;
generating, by the application program, first analysis data based at least in part on the first data item; and
transmitting the first analysis data to the software platform for processing by the software platform.

19. The method of claim 18, further comprising receiving and storing the first analysis data.

20. The method of claim 18, wherein prior to transmission of the QR code to the application program, receiving by the software platform an assignment associated with a property claim.

21. The method of claim 20, further comprising generating by the software platform the first item data based at least in part on the assignment.

22. The method of claim 21, further comprising encrypting by the software platform the first item data to generate the encrypted first item data and storing the encrypted first item data in the QR code.

23. The method of claim 22, further comprising sending by the software platform the QR code to the computing device.

24. The method of claim 22, further comprising displaying by the software platform the QR code.

25. The method of claim 18, further comprising downloading an insurance claims estimating assignment.

26. The method of claim 25, further comprising scanning a QR code associated with a property item listed in a particular line in the insurance claims estimating software application.

27. The method of claim 26, further comprising importing item data with a unique identifier, the item data associated with a property item.

28. The method of claim 27, further comprising receiving a sample of a physical structure based at least in part on the item data.

29. The method of claim 28, further comprising analyzing the sample to generate analysis data.

30. The method of claim 29, further comprising sending the analysis data to the particular line in the insurance claims estimating software application.

31. The method of claim 30, further comprising estimating a claim cost associated with the assignment.

32. The method of claim 18, further comprising converting the first item data into a data transfer format for transferring the first item data from the software platform to the computing device.

33. The method of claim 32, further comprising encrypting the first item data in the data transfer format.

34. The method of claim 33, further comprising encoding the encrypted first item data in the data transfer format.
